(19) United States
(12) Patent Application Publication
(10) Pub. No.: US 2007/0048716 A1
(43) Pub. Date: Mar. 1, 2007

(54) Learning system

(76) Inventors: Thomas Hsu, Andover, MA (US); Emmanouil A. Chaniotakis, Belmont, MA (US)

Correspondence Address: IANDIORIO & TESKA;INTELLECTUAL PROPERTY LAW ATTORNEYS, 260 BEAR HILL ROAD, WALTHAM, MA, 02451-1018, US

(21) Appl. No.: 11/217,736

(22) Filed: Sep. 1, 2005

(51) Int. Cl. G09B 5/00

(52) U.S. Cl. 434/317

(57) ABSTRACT

A learning system including a textbook and a control module physically integrated with the textbook for controlling a video playback device to display educational video and audio content on a monitor. The system may include one or more sensors in communication with the control module for measuring physical properties of matter and energy.

### FIELD OF THE INVENTION

This invention relates generally to a learning system and more particularly to an improved interactive learning system that provides for audiovisual instructional content to be synchronized with printed text and also provides the ability to measure and control instruments that measure physical properties of matter and energy.

### BACKGROUND OF THE INVENTION

Distance learning is an ideal means for many professional adults (e.g., science teachers) to pursue lifelong learning. Unfortunately, laboratory science courses are not widely available through distance learning because most people do not have access to scientific laboratories at home. Moreover, evening science courses for teachers are typically available only in a limited number of geographic areas.

At a time when an estimated fifty percent of the experienced science teachers are retiring, schools are having great difficulty finding and retaining science and math teachers, particularly in physics and chemistry. Instead, teachers of other subjects are often being asked to teach these subjects. Hence, there is a need for quality learning systems that can provide content and pedagogical instruction to “out-of-subject” teachers so they can become proficient in the needed science areas. The learning system needs to be affordable, accessible, and provide the ability to perform laboratory experiments in a home environment.

Learning science is best done through active observation, experimentation, and using sensors that are capable of accurately measuring physical parameters such as temperature, speed, force, time, and mass. Research shows that both students and teachers learn better by doing rather than by just watching, reading, or listening.

Conventional distance learning systems for science courses, e.g., “video courses” that utilize a video playback device, such as a DVD player, VCR, or similar device with a remote control are typically ineffective because the learning systems are passive and provide no interaction with the student.

In the past, a hybrid optical video disc called a “Laserdisc” was marketed along with textbooks as a learning system. The Laserdisc allowed the user to skip around and play video segments as needed. The video segments were keyed to pages of the printed book via a printed bar code. A bar code scanner in the Laserdisc player allowed the user to select the video segment to be played by scanning the bar code on the page. Interactivity was limited to skipping forward or backward to a single video segment. The Laserdisc system and conventional video courses do not include sensors for conducting laboratory experiments.

Sensors that can measure physical properties are known in education and industry. Measured data is typically displayed on a hand-held device, such as a Texas Instruments® Calculator Based Laboratory (CBL) or a computer with probes, e.g., probes available from Pasco Scientific or Vernier Scientific. However, these sensor systems are expensive and complicated to use.

Recent conventional computer based distance learning systems include online textbooks, video simulations, and probes for conducting experiments. However, these learning systems require an expensive computer with probes, a connection to the internet, are complicated to use, and often suffer from bandwidth problems and poor quality video. Moreover, computer based learning systems are machine (or operating system) specific, making them expensive and difficult to maintain.

To date, conventional learning systems have not combined a device to remotely control a video playback device, such a DVD player or VCR with a textbook as a single low-cost entity that can synchronize the chapter and page being read on the textbook with the video and audio content being played by the video playback device and also provide the ability to measure and control instruments that measure physical properties of matter and energy to facilitate performing experiments outside a science laboratory.

### BRIEF SUMMARY OF THE INVENTION

It is therefore an object of this invention to provide an improved learning system.

It is a further object of this invention to provide such a learning system that combines a device to remotely control a video playback device to play video and audio content with a textbook as a single entity.

It is a further object of this invention to provide such a learning system which synchronizes a chapter and page of the textbook with the video and audio content without the need for a bar code reader or similar device.

It is a further object of this invention to provide such a learning system which is compact and easily transportable.

It is a further object of this invention to provide such a learning system which provides for interactive learning without the need for a computer.

It is a further object of this invention to provide such a learning system which includes sensors for conducting laboratory experiments in a home environment without the need for specialized additional hardware or a computer.

It is a further object of this invention to provide such a learning system which is easy to use.

It is a further object of this invention to provide such a learning system which is less expensive.

It is a further object of this invention to provide such a learning system which utilizes common household items, such as a DVD player and a television.

This invention results from the realization that an improved, compact, easy to use, interactive learning system that eliminates the need for an expensive computer with probes or a CBL, can be effected with a textbook and a control module that is physically integrated with the textbook as a single unit such that the control module controls a video playback device (e.g., a DVD player) to play and synchronize the educational video and audio content with the chapter and page of the textbook. In a preferred embodiment, the learning system includes inexpensive sensors that can measure physical properties of matter and energy (e.g., temperature, speed, force, time, mass, and the like) so that laboratory experiments can be performed in a home environment, such as would be appropriate to a distance learning science course.

The subject invention, however, in other embodiments, need not achieve all these objectives and the claims hereof should not be limited to structures or methods capable of achieving these objectives.

This invention features a learning system including a textbook, and a control module physically integrated with the textbook for controlling a video playback device to display educational video and audio content on a monitor.

In one embodiment, the educational video and audio content may include one or more interactive video and/or audio simulations. The learning system may include one or more sensors in communication with the control module for measuring physical properties of matter and energy. The one or more sensors may measure physical properties chosen from a group consisting of: temperature, voltage, current, magnetic field, electric field, pressure, light, sound, radiation, ionic concentration, mass, speed, acceleration, and force. The control module may include a display window for displaying the measured physical properties of matter and energy. The control module may also include a remote control device for controlling the video playback device. The remote control device may control the video playback device using electromagnetic radiation, RF signals or infra-red signals. The remote control device may be hardwired to the video playback device. The control module may include an input device for synchronizing the educational video and audio content with a chapter and page of the textbook. The input device may provide for selecting and controlling the one or more interactive video and/or audio simulations. The input device may include video playback device control buttons, one or more dials and a keypad. The control module may include a processor responsive to the input device and in communication with the remote control device, the processor configured to control the remote control device to enable the video playback device to display the educational video and audio content and/or the one or more interactive video and/or audio simulations corresponding to the selected chapter and page of the textbook on the monitor. The one or more interactive video and/or audio simulations may include multiple pre-recorded video and/or audio scenarios and an indexing engine that indexes the scenarios and provides for inputting or changing simulation variables of the scenarios and observe the response of the scenarios to the simulation variables. The educational video and audio content and the one or more interactive video and/or audio simulations may be encoded on a media chosen from the group consisting of: magnetic media, optical media, and electronic media. The media may include electronic storage. The media may be chosen from the group consisting of a DVD disc, a CD-ROM disc, and flash memory. The processor may be in communication with one or more sensors, the processor configured to display measured values by the one or more sensors that indicate the measured physical properties of matter and energy on a display window. The simulation variables and the response thereto may be used to conduct a laboratory experiment. The one or more interactive video and/or audio simulations may include questions and selectable answers. The control module may include one or more input/output ports for connecting the one or more sensors. The one or more input/output ports may include a USB port. The video playback device may read and display electronically stored audiovisual data. The video playback device may be chosen from the group consisting of a DVD player, a VCR, a CD-ROM device, and a flash memory device. The monitor is chosen from the group consisting of a television, a computer monitor, a computer monitor integrated with the textbook, and a projection device. The video playback device may read the educational video and/or audio content and the one or more interactive video and/or audio simulations encoded on a media. A processor may be configured as a calculator. The learning system may further include a book cover for attaching to the textbook and for mounting the control module thereon.

This invention also features a learning system including a textbook, a control module physically integrated with the textbook for controlling a video playback device to display educational video and audio content on a monitor, and one or more sensors in communication with the control module for measuring physical properties of matter and energy.

In one embodiment, the educational video and audio content may include one or more interactive video and/or audio simulations. The one or more sensors may measure physical properties chosen from a group consisting of: temperature, voltage, current, magnetic field, electric field, pressure, light, sound, radiation, ionic concentration, mass, speed, acceleration, and force. The control module may include a display window for displaying the measured physical properties of matter and energy. The control module may include a remote control device for controlling the video playback device. The remote control device may control the video playback device using electromagnetic radiation, RF signals, or infra-red signals. The remote control device may be hardwired to the video playback device. The control module may include an input device for synchronizing the educational video and audio content with a chapter and page of the textbook. The input device provides for selecting and controlling the one or more interactive video and/or audio simulations. The input device may include video playback device control buttons, one or more dials and a keypad. The control module may include a processor responsive to the input device and in communication with the remote control device, the processor configured to control the remote control device to enable the video playback device to display the educational video and audio content and/or the one or more interactive video and/or audio simulations corresponding to the selected chapter and page of the textbook on the monitor. The one or more interactive video and/or audio simulations may include multiple pre-recorded video and/or audio scenarios and an indexing engine that indexes the scenarios and provides for inputting or changing simulation variables of the scenarios and observe the response of the scenarios to the simulation variables. The educational video and audio content and the one or more interactive video and/or audio simulations may be encoded on a media chosen from the group consisting of: magnetic media, optical media, and electronic media. The media may include electronic storage. The media may be chosen from the group consisting of a DVD disc, a CD-ROM disc, and flash memory. The processor may be in communication with one or more sensors, the processor configured to display measured values by the one or more sensors that indicate the measured physical properties of matter and energy on a display window. The simulation variables and the response thereto may be used to conduct a laboratory experiment. The one or more interactive video and/or audio simulations may include questions and selectable answers. The control module may include one or more input/output ports for connecting the one or more sensors. The one or more input/output ports may include a USB port. The video playback device may read and display electronically stored audiovisual data. The video playback device may be chosen from the group consisting of: a DVD player, a VCR, a CD-ROM device, and a flash memory device. The monitor may be chosen from the group consisting of a television, a computer monitor, a computer monitor integrated with the textbook, and a projection device. The video playback device may read the educational video and/or audio content and the one or more interactive video and/or audio simulations encoded on a media. A processor may be configured as a calculator. The learning system may further include a book cover for attaching to the textbook and for mounting the control module thereon.

This invention further features a learning system including a textbook, a control module physically integrated with the textbook for controlling a video playback device to display educational video and audio content on a monitor, and the control module including a remote control device for controlling the video playback device, and one or more sensors in communication with the control module for measuring physical properties of matter and energy.

This invention also features a learning system including a textbook, a control module physically integrated with the textbook for controlling a video playback device to display educational video and audio content and/or one or more interactive video and/or audio simulations on a monitor, the control module including a remote control device for controlling the video playback device, and one or more sensors in communication with the control module for measuring physical properties of matter and energy.

This invention further features a learning system including a textbook, and a non-user programmable control module physically integrated with the textbook for controlling a video playback device to display educational video and audio content on a monitor.

### BRIEF DESCRIPTION OF THE DRAWINGS

Other objects, features and advantages will occur to those skilled in the art from the following description of a preferred embodiment and the accompanying drawings, in which:

FIG. 1 is a schematic block diagram of one embodiment of a learning system in accordance with this invention;

FIG. 2 is a schematic diagram showing the various control buttons, and sensor display window of the control module shown in FIG. 1;

FIGS. 3A and 3B are views showing examples of interactive video simulations employed by the learning system of this invention;

FIGS. 4A-4E are views showing interactive video simulations of questions and selectable answers employed by the learning system of this invention; and

FIG. 5 is a schematic block diagram showing the primary components of the controller module shown in FIG. 1;

FIG. 6 is a schematic diagram of a preferred embodiment of the learning system of this invention integrated with the textbook shown.

### PREFERRED EMBODIMENT

Aside from the preferred embodiment or embodiments disclosed below, this invention is capable of other embodiments and of being practiced or being carried out in various ways. Thus, it is to be understood that the invention is not limited in its application to the details of construction and the arrangements of components set forth in the following description or illustrated in the drawings. If only one embodiment is described herein, the claims hereof are not to be limited to that embodiment. Moreover, the claims hereof are not to be read restrictively unless there is clear and convincing evidence manifesting a certain exclusion, restriction, or disclaimer.

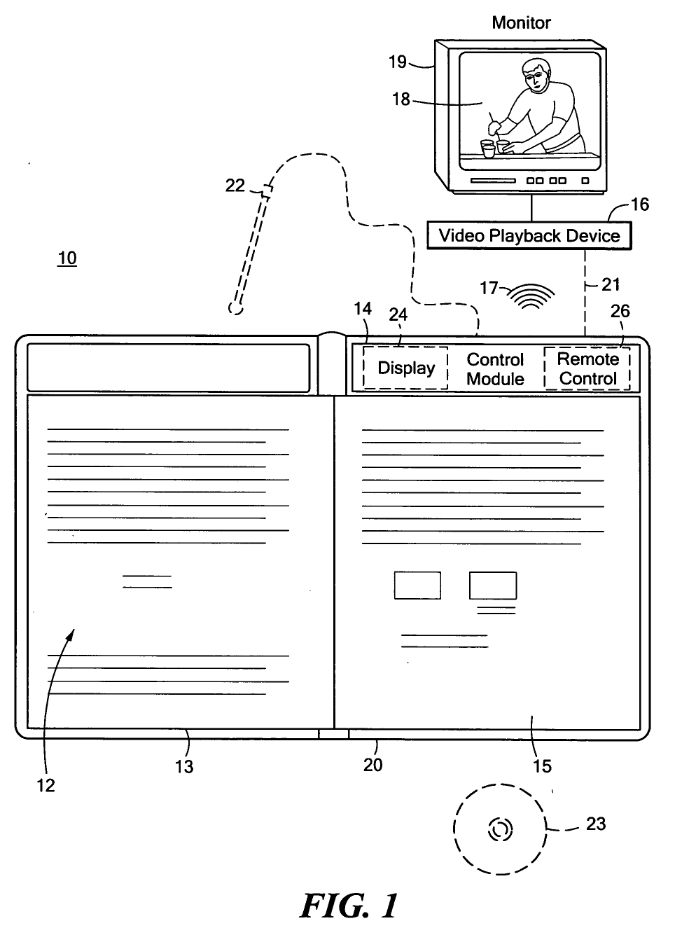

There is shown in FIG. 1 an example of learning system 10 in accordance with this invention including textbook 12 and control module 14 that controls video playback device 16 via remote control device 26 to display educational video and audio content 18 on monitor 19, e.g., a television, computer monitor, a computer monitor integrated with textbook 12, or a projection device. In one design, monitor 19 may be integrated with textbook 12. Control module 14 is physically integrated with textbook 12, e.g., control module 14 is mounted on textbook cover 20 that is attached to textbook 12. Learning system 10 opens like a hardcover textbook except the pages, e.g., page 13 and page 15, are shorter than cover 20 (e.g., about 2 inches shorter) to accommodate for control module 14. Thus, learning system 10 with textbook 12 and control module 14 is about the same size as a typical textbook, and thus is compact and easily transportable.

As discussed in detail below, educational video and audio content 18 is typically a video movie, simulation, or animation that is synchronized with the chapter and page of textbook 12, that further explains a particular educational topic that is being read on textbook 12 by the student. Educational video and audio content 18 also typically includes one or more interactive video and/or audio simulations that are used to further explain a particular scientific phenomenon such as the relationship between molecular motion and temperature. The interactive video and/or audio simulations also provide the ability to conduct simulated experiments.

Remote control device 26 in control module 14 controls video playback device 16 using electromagnetic radiation, RF signals, infrared signals, and the like, indicated at 17, or may be directly hardwired to video playback device 16, as indicated by dashed line 21. Video playback device 16 is typically a DVD player, a CD-ROM device, a VCR, a flash memory device, or similar video playback device known to those skilled in the art.

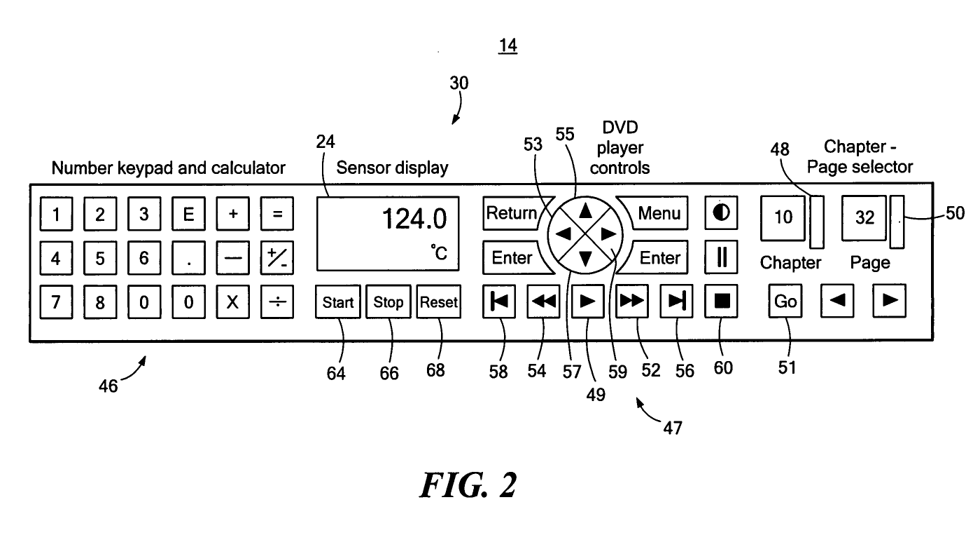

Control module 14, FIG. 2 includes input device 30 that includes chapter dial 48, page dial 50, go button 51, video playback control buttons, indicated generally by arrow 47 and keypad 46. Input device 30 synchronizes educational video and audio content 18, FIG. 1, played by video playback device 16 and displayed on monitor 19 with the current chapter and page of textbook 12. In operation, the student selects the current chapter with chapter dial 48, FIG. 2 and the page with page dial 50 and then presses go button 51. Pressing go button 51 causes video playback device 16 to display the appropriate portion of educational video and audio content 18 on monitor 19 with the selected chapter and page of textbook 12 being read by the student. In this way, static images on the chapter and page of textbook 12, FIG. 1, being read by the student come to life on monitor 19 with rich visual images and full sound to create a more dynamic, interactive learning experience for the student. The student can control how educational video and audio content 18 is played by video playback device 16 using the various video playback device control buttons, e.g., using play button 49, FIG. 2, fast forward button 52, rewind button 54, begin button 58, end button 56, stop button 60, and arrow buttons 53, 55, 57 and 59 that function similar to a remote control for a typical video playback device (e.g., a DVD player) as known to those skilled in the art.

As discussed above, educational video and audio content 18 preferably include interactive video and/or audio simulations that are used to further explain a particular scientific phenomenon related to text being read on textbook 12, FIG. 1. The interactive video and/or audio simulations may be appended to the educational video and audio content 18 or may be selected using the various video control buttons discussed above.

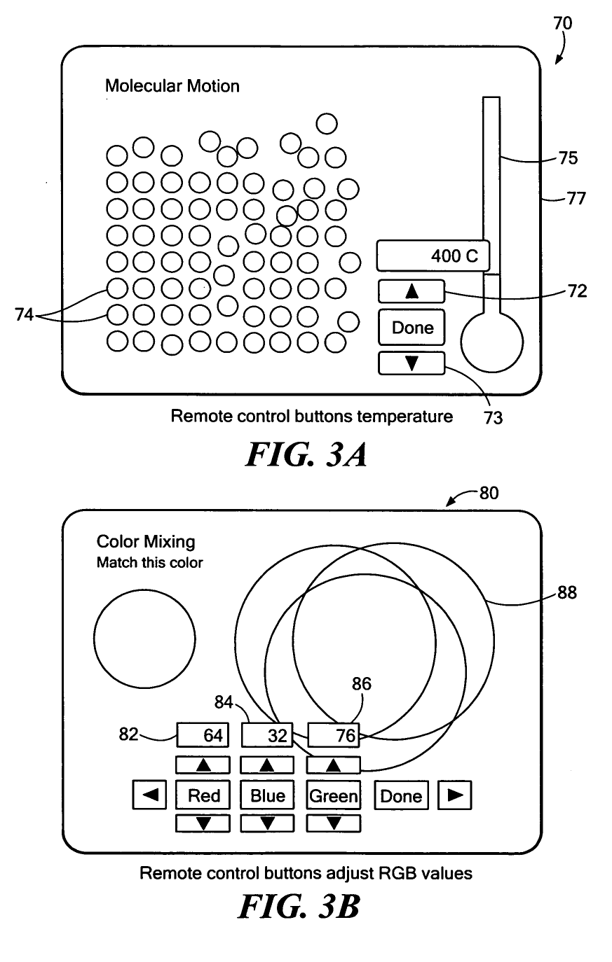

For example, view 70, FIG. 3A shows a view of a pre-recorded video simulation of molecular motion of molecules 74 and their corresponding temperature, indicated by thermometer 75 and window 77 played by video playback device 16, FIG. 1 and displayed on monitor 19. Using arrow buttons 55 and 57, FIG. 2, students can increase or decrease the relative motion of molecules 74, shown on the screen by arrows 72 and 73 and observe the change in temperature, e.g., increasing the molecular motion will increase the temperature and vice versa. The simulation is designed so that the student must determine the melting point of a material by observing the motion of its molecules in the video simulation. The student is asked to identify an unknown material by matching its melting point with a list of substances they are given. The student solves a real problem by looking at molecular motion and thereby develops a strong conceptual understanding of how atoms and molecules relate to everyday experience. The result is that an interactive simulated laboratory experiment can be conducted.

Similarly, view 80, FIG. 3B shows a view of a pre-recorded video simulation used for a color mixing experiment. Similarly, using arrow buttons 53, 55, 57 and 59, FIG. 2, the student can input various percentages of the colors red, green and blue indicated at 82, 84 and 86, respectively. The result of the combination of the various percentages of the colors is indicated at 88.

As shown above, learning system 10 of this invention uses several techniques to break up the video experience so that the student must actively interact with the current lesson being read on textbook 12. The student can first play the educational video and audio content 18 and then play the interactive video and/or audio simulations. By combining and synchronizing the video and/or audio simulations with the context of the lesson on textbook 12, the concepts learned through the simulation are much more readily understood.

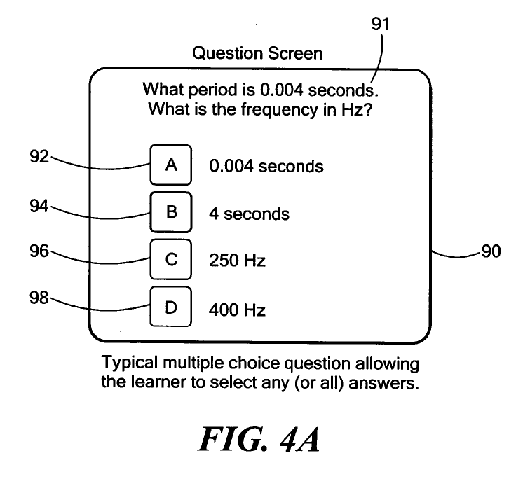

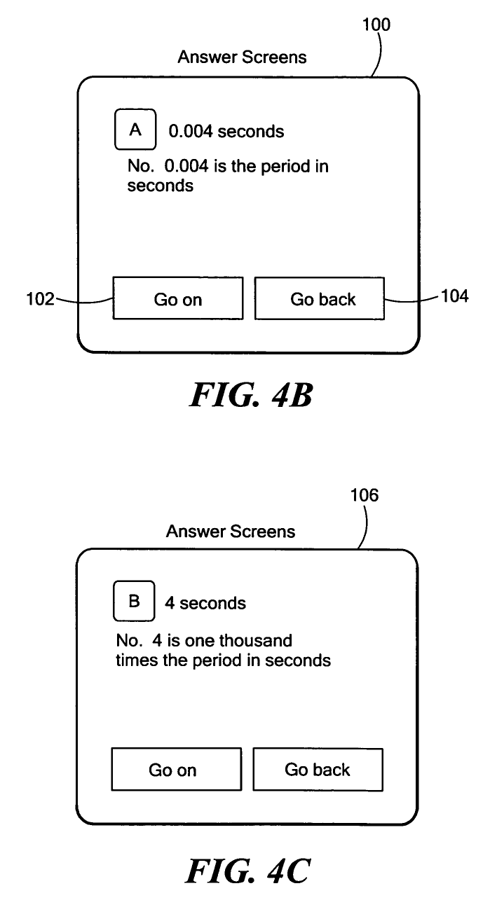

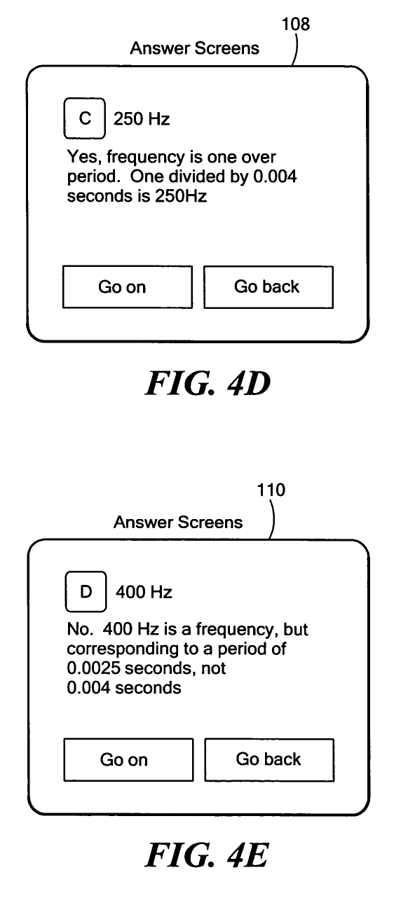

Another example of an interactive video and/or audio simulation may include multiple-choice (or true/false) questions and answers. In this type of interactive video simulation, the student must choose an answer based on the material just read in textbook 12. Teachers (e.g., “out-of-subject” teachers that are now students) expressed great enthusiasm for learning system 10 as they felt no peer pressure to know the right answer and learned by looking at all the answers. For example, view 90, FIG. 4A, shows a view of a pre-recorded video question and answer simulation played by video playback device 16, FIG. 1 and displayed on monitor 19 that teaches the relationship between period and frequency. In this example, view 90 generates a question, indicated at 91, and selectable answers A, B, C, and D, indicated at 92, 94, 96 and 98, respectively, that are selected using various buttons of control module 14 described above. Selection of answer ‘A’ generates view 100, FIG. 4B which explains why answer ‘A’ is incorrect. The student can than continue on, as indicated at 102 or go back as indicated at 104. Similarly, the student's selection of response ‘B’, indicated at 94, FIG. 4A generates view 106, FIG. 4C which explains why answer ‘B’ is incorrect. Selecting answer ‘C’, indicated at 96, FIG. 4A generates view 108, FIG. 4D which explains why answer ‘C’ is correct. Finally, selecting answer D, indicated at 98, FIG. 4A generates view 110, FIG. 4F which explains why answer ‘D’ is incorrect. Thus, the interactive video simulations of learning system 10 of this invention can utilize pre-defined questions and selectable answers to increase and improve the learning experience.

The result is an improved, effective, interactive, and distance learning system that is easy to use, compact and easily transportable, and eliminates the need for a computer. Learning system 10 is also inexpensive and can be economically manufactured and mass produced. Moreover, utilizing common household items such as a DVD player, a VCR and a television further reduces the cost of the system.

In a preferred embodiment, learning system 10, FIG. 1 includes one or more sensors, e.g., sensor 22, in communication with control module 14 that are used to measure physical properties of matter and energy, e.g., temperature, voltage, current, pressure, light, sound, radiation, ionic concentration, mass, speed, acceleration, force and the like. Sensor 22 is typically an inexpensive sensor, e.g., a temperature sensor, a voltmeter, a pH sensor, conductivity sensor, magnetic flux, photosensor, or similar sensors known to those skilled in the art. Display window 24 (shown in greater detail in FIG. 2) indicates the measured physical properties of matter and energy measured by sensor 22. For example, sensor 22 may be a temperature sensor that measures the temperature of a liquid or gas, or a voltmeter that measures voltage or current of an electronic component or any equivalent sensor known to those skilled in the art. Sensor 22 is in communication with control module 14 (discussed below) and provides students with the ability to conduct laboratory experiments in a home environment without needing access to a specialized science lab. The student typically reads about the laboratory experiment on textbook 12. Educational video and audio content 18 is then synchronized and played by video playback device 16 using chapter dial 48, FIG. 2, page dial 50 and go button 51 (discussed above) and displayed on monitor 19 to further explain how the student should conduct the experiment. The student uses one or more sensors to conduct the laboratory experiment. For example, the student connects the desired sensor to control module 14 via the input/output device (discussed below) and begins measuring physical properties of matter and energy by pressing start button 64. Stop button 66 is used to stop the measuring and reset button 68 resets the current measurement. To further enhance the experiment, video and/or audio simulations may be played using the video playback control buttons discussed above.

The result is a complete, interactive learning system that provides for conducting laboratory experiments needed for distance learning of science courses at home that is easy to use and eliminates the need for an expensive computer with probes or a CBL. Learning system 10 combines the strengths of three separate technologies, e.g., a textbook, a remote control device for a video playback device, and a sensor, into a robust and effective learning system. Moreover, as discussed above, learning system 10 is about the size of a typical textbook and hence is compact and easily transportable.

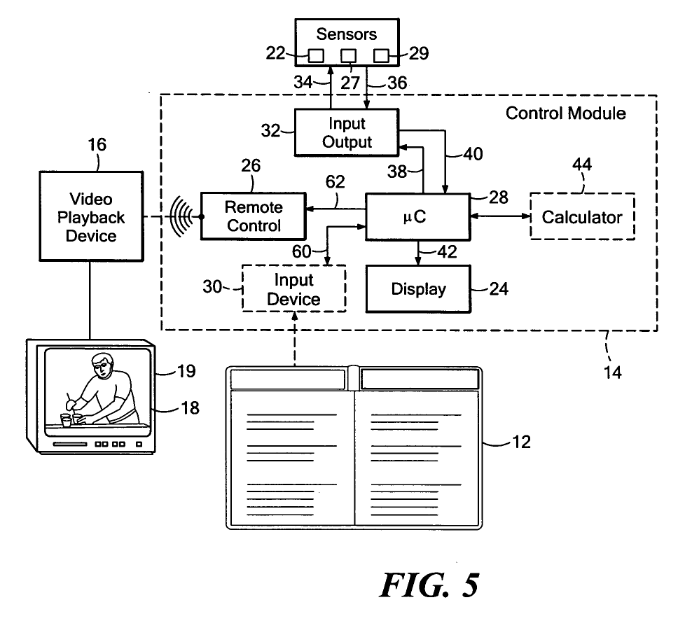

Control module 14, FIG. 5, where like parts have been given like numbers, is non-user programmable (unlike a computer) and includes processor 28, e.g., a microcontroller or similar device, in communication with remote control device 26, input/output device 32, one or more sensors, e.g., sensor 22, sensor 27, and/or sensor 29, input device 30, and display window 24. Processor 28 is configured to receive a signal from input device 30, e.g., chapter dial 48, FIG. 2, page dial 50, go button 51, and the video playback device control buttons, indicated generally by arrow 47 (discussed above) and by line 60, FIG. 5 and sends control signals by line 62 to remote control device 26. Remote control device 26 enables video playback device 16 using electromagnetic radiation, RF signals, infrared signals, and the like (discussed above), to display and synchronize educational video and audio content 18 on monitor 19 with the current chapter and page of textbook 12. Processor 28 is in communication with input/output device 32 by lines 38 and 40. Input/output device 32, e.g., a USB port or similar device, is responsive to one or more sensors, e.g., sensor 22, sensor 27 and/or sensor 29, by lines 34 and 36. Processor 28 is reconfigured to process signals on lines 38 and 40 from input/output device 32 and display the measured values of the physical properties measured by sensors 22-29 on display window 24. Processor 28 may also be configured as calculator 44 and utilizes keypad 46, FIG. 2, for inputting numbers and arithmetic operations. Keypad 46 is also used for calibrating sensors 22-29, FIG. 5. Video playback device control buttons indicated generally by arrow 47, FIG. 2 communicate with processor 28, FIG. 5, by line 60. Processor 28 then communicates signals to remote control device 26 by line 62 to enable video playback device 16 to play educational video and audio content 18 and/or interactive video and/or audio simulations on monitor 19.

In a preferred embodiment, the interactive video and/or audio simulations discussed above include multiple pre-recorded video and/or audio scenarios (e.g., multiple short video segments) and indexing engine software that indexes the scenarios to provide for inputting and/or changing simulation variables using the various control buttons of input device 30. Indexing software for indexing the multiple pre-recorded video and/or audio scenarios is known to those skilled in the art, such as DVD STUDIO PRO®.

The educational video and audio content that includes video and/or audio simulations that include multiple pre-recorded video and/or audio scenarios and indexing engine software that indexes the scenarios is typically encoded on a media, such as magnetic media, optical media, or electronic media, e.g., a DVD disc, a CD-ROM disc, flash memory, and the like, such as DVD disc 23, FIG. 1. Video playback device 16 reads the educational video and audio content 18 encoded on the media and plays it on monitor 19.

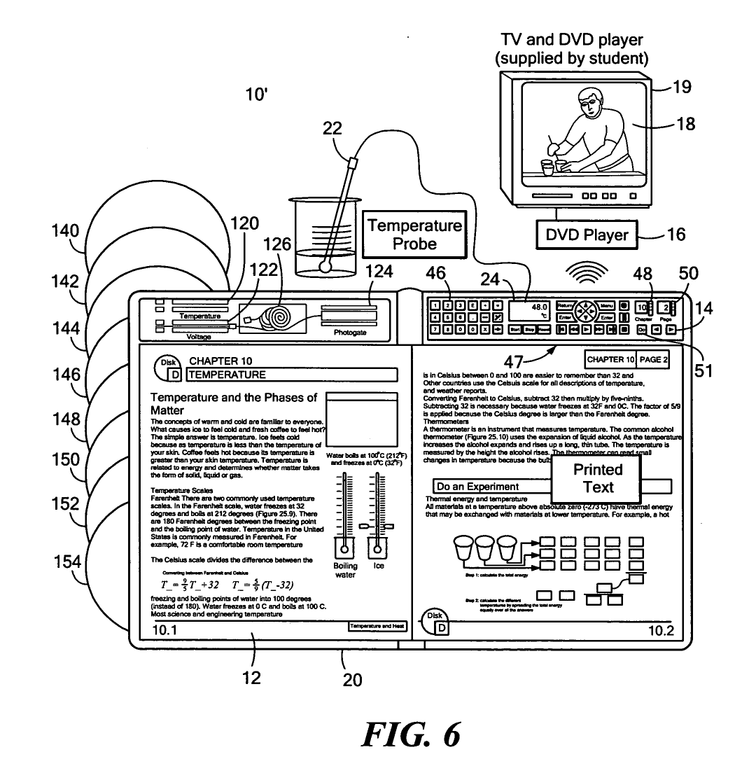

FIG. 6 shows a preferred embodiment of interactive learning system 10′ of this invention that includes textbook 12, control module 14 with keypad 46, chapter dial 48, page dial 50, go button 51, the video playback control buttons shown generally by arrow 47, one or more sensors, e.g., sensor 22, display window 24, and video playback device 16 connected to a television 19 that displays educational video and audio content 18 and interactive video and/or audio simulations. In this design, cover 20 includes storage areas 120, 122, 124 and 126 for storing additional sensors, e.g., a temperature sensor, a voltage sensor, a photogate sensor, or other similar sensors known to those skilled in the art. In this example, DVD discs 140-154 contain the educational video and audio subject matter and the interactive video and/or audio simulations used by learning system 10′.

Although specific features of the invention are shown in some drawings and not in others, this is for convenience only as each feature may be combined with any or all of the other features in accordance with the invention. The words “including”, “comprising”, “having”, and “with” as used herein are to be interpreted broadly and comprehensively and are not limited to any physical interconnection. Moreover, any embodiments disclosed in the subject application are not to be taken as the only possible embodiments. Other embodiments will occur to those skilled in the art and are within the following claims.

In addition, any amendment presented during the prosecution of the patent application for this patent is not a disclaimer of any claim element presented in the application as filed: those skilled in the art cannot reasonably be expected to draft a claim that would literally encompass all possible equivalents, many equivalents will be unforeseeable at the time of the amendment and are beyond a fair interpretation of what is to be surrendered (if anything), the rationale underlying the amendment may bear no more than a tangential relation to many equivalents, and/or there are many other reasons the applicant can not be expected to describe certain insubstantial substitutes for any claim element amended.

What is claimed is:

1. A learning system comprising:
a textbook; and
a control module physically integrated with the textbook for controlling a video playback device to display educational video and audio content on a monitor.

2. The learning system of claim 1 in which the educational video and audio content includes one or more interactive video and/or audio simulations.

3. The learning system of claim 1 further including one or more sensors in communication with the control module for measuring physical properties of matter and energy.

4. The learning system of claim 3 in which the one or more sensors measure physical properties chosen from a group consisting of: temperature, voltage, current, magnetic field, electric field, pressure, light, sound, radiation, ionic concentration, mass, speed, acceleration, and force.

5. The learning system of claim 3 in which the control module includes a display window for displaying the measured physical properties of matter and energy.

6. The learning system of claim 2 in which the control module includes a remote control device for controlling the video playback device.

7. The learning system of claim 6 in which the remote control device controls the video playback device using electromagnetic radiation.

8. The learning system of claim 6 in which the remote control device controls the video playback device using RF signals.

9. The learning system of claim 6 in which the remote control device controls the video playback device using infra-red signals.

10. The learning system of claim 6 in which the remote control device is hardwired to the video playback device.

11. The learning system of claim 6 in which the control module includes an input device for synchronizing the educational video and audio content with a chapter and page of the textbook.

12. The learning system of claim 11 in which the input device provides for selecting and controlling the one or more interactive video and/or audio simulations.

13. The learning system of claim 12 in which the input device includes video playback device control buttons, one or more dials and a keypad.

14. The learning system of claim 11 in which the control module includes a processor responsive to the input device and in communication with the remote control device, the processor configured to control the remote control device to enable the video playback device to display the educational video and audio content and/or the one or more interactive video and/or audio simulations corresponding to the selected chapter and page of the textbook on the monitor.

15. The learning system of claim 12 in which the one or more interactive video and/or audio simulations include multiple pre-recorded video and/or audio scenarios and an indexing engine that indexes the scenarios and provides for inputting or changing simulation variables of the scenarios and observe the response of the scenarios to the simulation variables.

16. The learning system of claim 15 in which the educational video and audio content and the one or more interactive video and/or audio simulations are encoded on a media chosen from the group consisting of: magnetic media, optical media, and electronic media.

17. The learning system of claim 16 in which said media includes electronic storage.

18. The learning system of claim 16 in which said media is chosen from the group consisting of: a DVD disc, a CD-ROM disc, and flash memory.

19. The learning system of claim 14 in which the processor is in communication with one or more sensors, the processor configured to display measured values by the one or more sensors that indicate the measured physical properties of matter and energy on a display window.

20. The learning system of claim 15 in which the simulation variables and the response thereto are used to conduct a laboratory experiment.

21. The learning system of claim 15 in which the one or more interactive video and/or audio simulations include questions and selectable answers.

22. The learning system of claim 14 in which the control module includes one or more input/output ports for connecting the one or more sensors.

23. The learning system of claim 22 in which the one or more input/output ports include a USB port.

24. The learning system of claim 1 in which said video playback device reads and displays electronically stored audiovisual data.

25. The learning system of claim 24 in which said video playback device is chosen from the group consisting of: a DVD player, a VCR, a CD-ROM device, and a flash memory device.

26. The learning system of claim 1 in which the monitor is chosen from the group consisting of a television, a computer monitor, a computer monitor integrated with the textbook, and a projection device.

27. The learning system of claim 16 in which the video playback device reads the educational video and/or audio content and the one or more interactive video and/or audio simulations encoded on a media.

28. The learning system of claim 14 in which a processor is configured as a calculator.

29. The learning system of claim 1 further including a book cover for attaching to the textbook and for mounting the control module thereon.

30. A learning system comprising:
a textbook;
a control module physically integrated with the textbook for controlling a video playback device to display educational video and audio content on a monitor; and
one or more sensors in communication with the control module for measuring physical properties of matter and energy.

31. The learning system of claim 30 in which the educational video and audio content includes one or more interactive video and/or audio simulations.

32. The learning system of claim 30 in which the one or more sensors measure physical properties chosen from a group consisting of: temperature, voltage, current, magnetic field, electric field, pressure, light, sound, radiation, ionic concentration, mass, speed, acceleration, and force.

33. The learning system of claim 30 in which the control module includes a display window for displaying the measured physical properties of matter and energy.

34. The learning system of claim 31 in which the control module includes a remote control device for controlling the video playback device.

35. The learning system of claim 34 in which the remote control device controls the video playback device using electromagnetic radiation.

36. The learning system of claim 34 in which the remote control device controls the video playback device using RF signals.

37. The learning system of claim 34 in which the remote control device controls the video playback device using infra-red signals.

38. The learning system of claim 34 in which the remote control device is hardwired to the video playback device.

39. The learning system of claim 34 in which the control module includes an input device for synchronizing the educational video and audio content with a chapter and page of the textbook.

40. The learning system of claim 39 in which the input device provides for selecting and controlling the one or more interactive video and/or audio simulations.

41. The learning system of claim 40 in which the input device includes video playback device control buttons, one or more dials and a keypad.

42. The learning system of claim 39 in which the control module includes a processor responsive to the input device and in communication with the remote control device, the processor configured to control the remote control device to enable the video playback device to display the educational video and audio content and/or the one or more interactive video and/or audio simulations corresponding to the selected chapter and page of the textbook on the monitor.

43. The learning system of claim 40 in which the one or more interactive video and/or audio simulations include multiple pre-recorded video and/or audio scenarios and an indexing engine that indexes the scenarios and provides for inputting or changing simulation variables of the scenarios and observe the response of the scenarios to the simulation variables.

44. The learning system of claim 43 in which the educational video and audio content and the one or more interactive video and/or audio simulations are encoded on a media chosen from the group consisting of: magnetic media, optical media, and electronic media.

45. The learning system of claim 44 in which said media includes electronic storage.

46. The learning system of claim 44 in which media is chosen from the group consisting of: a DVD disc, a CD-ROM disc, and flash memory.

47. The learning system of claim 42 in which the processor is in communication with one or more sensors, the processor is configured to display measured values by the one or more sensors that indicate the measured physical properties of matter and energy on a display window.

48. The learning system of claim 43 in which the simulation variables and the response thereto are used to conduct a laboratory experiment.

49. The learning system of claim 43 in which the one or more interactive video and/or audio simulations include questions and selectable answers.

50. The learning system of claim 42 in which the control module includes one or more input/output ports for connecting the one or more sensors.

51. The learning system of claim 50 in which the one or more input/output ports include a USB port.

52. The learning system of claim 30 in which said video playback device reads and displays electronically stored audiovisual data.

53. The learning system of claim 52 in which the video playback device is chosen from the group consisting of: a DVD player, a VCR, a CD-ROM device, and a flash memory device.

54. The learning system of claim 30 in which the monitor is chosen from the group consisting of: a television, a computer monitor, a computer monitor integrated with the textbook, and a projection device.

55. The learning system of claim 44 in which the video playback device reads the educational video and/or audio content and the one or more interactive video and/or audio simulations encoded on a media.

56. The learning system of claim 42 in which a processor is configured as a calculator.

57. The learning system of claim 30 further including a book cover for attaching to the textbook and for mounting the control module thereon.

58. A learning system comprising:
a textbook;
a control module physically integrated with the textbook for controlling a video playback device to display educational video and audio content on a monitor, said control module including a remote control device for controlling the video playback device; and
one or more sensors in communication with the control module for measuring physical properties of matter and energy.

59. A learning system comprising:
a textbook;
a control module physically integrated with the textbook for controlling a video playback device to display educational video and audio content and/or one or more interactive video and/or audio simulations on a monitor, said control module including a remote control device for controlling the video playback device; and
one or more sensors in communication with the control module for measuring physical properties of matter and energy.

60. A learning system comprising:
a textbook; and
a non-user programmable control module physically integrated with the textbook for controlling a video playback device to display educational video and audio content on a monitor.
